(19) United States
(12) Patent Application Publication
(10) Pub. No.: US 2025/0048180 A1
(43) Pub. Date: Feb. 6, 2025

(54) CONFLICT PROCESSING METHOD, TERMINAL, AND NETWORK SIDE DEVICE

(71) Applicant: VIVO MOBILE COMMUNICATION CO., LTD., Dongguan (CN)

(72) Inventors: Dongru LI, Dongguan (CN); Kai WU, Dongguan (CN); Zuolong YING, Dongguan (CN)

(73) Assignee: VIVO MOBILE COMMUNICATION CO., LTD., Dongguan (CN)

(21) Appl. No.: 18/920,847

(22) Filed: Oct. 18, 2024

Related U.S. Application Data
(63) Continuation of application No. PCT/CN2023/088619, filed on Apr. 17, 2023.

(30) Foreign Application Priority Data
Apr. 20, 2022 (CN) 202210417256.7

(51) Int. Cl. H04W 28/06; H04W 72/20; H04W 72/51; H04W 72/566

(52) U.S. Cl. CPC H04W 28/06; H04W 72/20; H04W 72/51; H04W 72/569

(57) ABSTRACT

This application discloses a conflict processing method, a terminal, and a network side device. The conflict processing method includes: performing, by a first device, a target operation in a case that there is a conflict between transmission of first information and transmission of second information. The target operation includes discarding the transmission of the first information or discarding the transmission of the second information, the first information includes information carried in a channel or a signal of a backscatter communication system, and the second information includes information other than the first information.

### CROSS-REFERENCE TO RELATED APPLICATIONS

This application is a continuation of International Application No. PCT/CN 2023/088619, filed on Apr. 17, 2023, which claims priority to Chinese Patent Application No. 202210417256.7, filed on Apr. 20, 2022. The entire contents of each of the above-referenced applications are expressly incorporated herein by reference.

### TECHNICAL FIELD

This application pertains to the field of communication technologies, and in particular, to a conflict processing method, a terminal, and a network side device.

### BACKGROUND

Backscatter communication (BSC) means that a backscatter communication device performs signal modulation by using a radio frequency signal in another device or an environment to transmit information. The backscatter communication device may be a tag device in conventional radio frequency identification (RFID) or a passive internet of things (Passive-IoT) device.

Transmission of BSC services carried in a mobile communication system (for example, 5G new radio (NR)) is discussed in a related technology. However, impact of transmission of a channel or a signal of a backscatter communication system on transmission of an existing new radio (NR) channel or signal is not considered. Consequently, communication performance is affected for a conflict occurred between the transmission of the channel or the signal of the backscatter communication system and the transmission of the NR channel or signal.

### SUMMARY

Embodiments of this application provide a conflict processing method, a terminal, and a network side device.

According to a first aspect, a conflict processing method is provided. The method includes: A first device performs a target operation in a case that there is a conflict between transmission of first information and transmission of second information, where the target operation includes discarding the transmission of the first information or discarding the transmission of the second information; and the first information includes information carried in a channel or a signal of a backscatter communication system, and the second information includes information other than the first information.

According to a second aspect, a conflict processing method is provided. The method includes: A network side device determines a transmission priority of first information and a transmission priority of second information, where the first information includes information carried in a channel or a signal of a backscatter communication system, and the second information includes information other than the first information; and the network side device performs resource allocation and/or transmission of the first information and the second information based on the transmission priority.

According to a third aspect, a conflict processing apparatus is provided. The apparatus includes: a processing module, configured to perform a target operation in a case that there is a conflict between transmission of first information and transmission of second information, where the target operation includes discarding the transmission of the first information or discarding the transmission of the second information; and the first information includes information carried in a channel or a signal of a backscatter communication system, and the second information includes information other than the first information.

According to a fourth aspect, a conflict processing apparatus is provided. The apparatus includes: a processing module, configured to determine a transmission priority of first information and a transmission priority of second information, where the first information includes information carried in a channel or a signal of a backscatter communication system, and the second information includes information other than the first information; and a transmission module, configured to perform resource allocation and/or transmission of the first information and the second information based on the transmission priority.

According to a fifth aspect, a terminal is provided. The terminal includes a processor and a memory, and the memory stores a program or an instruction that can be run on the processor. When the program or the instruction is executed by the processor, steps of the method according to the first aspect are implemented.

According to a sixth aspect, a terminal is provided. The terminal includes a processor and a communication interface. The processor is configured to perform a target operation in a case that there is a conflict between transmission of first information and transmission of second information, where the target operation includes discarding the transmission of the first information or discarding the transmission of the second information; and the first information includes information carried in a channel or a signal of a backscatter communication system, and the second information includes information other than the first information.

According to a seventh aspect, a network side device is provided. The network side device includes a processor and a memory, and the memory stores a program or an instruction that can be run on the processor. When the program or the instruction is executed by the processor, steps of the method according to the first aspect or the second aspect are implemented.

According to an eighth aspect, a network side device is provided. The network side device includes a processor and a communication interface. The processor is configured to perform a target operation in a case that there is a conflict between transmission of first information and transmission of second information, where the target operation includes discarding the transmission of the first information or discarding the transmission of the second information; and the first information includes information carried in a channel or a signal of a backscatter communication system, and the second information includes information other than the first information. In some embodiments, the processor is configured to determine a transmission priority of first information and a transmission priority of second information, where the first information includes information carried in a channel or a signal of a backscatter communication system, and the second information includes information other than the first information; and the communication interface is configured to perform resource allocation and/or transmission of the first information and the second information based on the transmission priority.

According to a ninth aspect, a conflict processing system is provided. The conflict processing system includes a terminal and a network side device, the terminal may be configured to perform steps of the method according to the first aspect, and the network side device may be configured to perform steps of the method according to the first aspect or the second aspect.

According to a tenth aspect, a readable storage medium is provided. The readable storage medium stores a program or an instruction. When the program or the instruction is executed by a processor, steps of the method according to the first aspect or steps of the method according to the second aspect are implemented.

According to an eleventh aspect, a chip is provided. The chip includes a processor and a communication interface, the communication interface is coupled to the processor, and the processor is configured to run a program or an instruction, to implement steps of the method according to the first aspect or steps of the method according to the second aspect.

According to a twelfth aspect, a computer program/program product is provided. The computer program/program product is stored in a storage medium, and the computer program/program product is executed by at least one processor to implement steps of the method according to the first aspect or steps of the method according to the second aspect.

In embodiments of the this application, the first device may discard the transmission of the first information or discard the transmission of the second information in a case that there is the conflict between the transmission of the first information and the transmission of the second information; and the first information includes the information carried in the channel or the signal of the backscatter communication system, and the second information includes the information other than the first information. In embodiments of this application, a decrease in communication reliability due to the transmission conflict can be reduced or avoid, and communication robustness can be improved.

### BRIEF DESCRIPTION OF DRAWINGS

FIG. 1 is a schematic diagram of a wireless communication system according to an embodiment of this application;

FIG. 2 is a schematic flowchart of a conflict processing method according to an embodiment of this application;

FIG. 3 is a schematic diagram of specific application of a conflict processing method according to an embodiment of this application;

FIG. 4 is a schematic flowchart of a conflict processing method according to an embodiment of this application;

FIG. 5 is a schematic structural diagram of a conflict processing apparatus according to an embodiment of this application;

FIG. 6 is a schematic structural diagram of a conflict processing apparatus according to an embodiment of this application;

FIG. 7 is a schematic structural diagram of a communication device according to an embodiment of this application;

FIG. 8 is a schematic structural diagram of a terminal according to an embodiment of this application; and

FIG. 9 is a schematic structural diagram of a network side device according to an embodiment of this application.

### DETAILED DESCRIPTION

The following clearly describes technical solutions in embodiments of this application with reference to accompanying drawings in embodiments of this application. It is clear that the described embodiments are some but not all of embodiments of this application. All other embodiments obtained by a person of ordinary skill in the art based on embodiments of this application shall fall within the protection scope of this application.

The terms “first”, “second”, and the like in this specification and the claims of this application are used to distinguish between similar objects instead of describing a specific order or sequence. It should be understood that, the terms used in such a way is interchangeable in proper circumstances, so that embodiments of this application can be implemented in an order other than the order illustrated or described herein. Objects classified by “first” and “second” are usually of a same type, and the quantity of objects is not limited. For example, there may be one or more first objects. In addition, in this specification and the claims, “and/or” represents at least one of connected objects, and the character “/” generally represents an “or” relationship between associated objects.

It should be noted that the technologies described in embodiments of this application are not limited to a Long Term Evolution (LTE)/LTE-Advanced (LTE-A) system, and may also be used in other wireless communication systems such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency Fivision Multiple Access (SC-FDMA) system, and another system. The terms “system” and “network” in embodiments of this application may be used interchangeably. The technologies described can be applied to both the systems and the radio technologies mentioned above as well as to other systems and radio technologies. A New Radio (NR) system is described in the following descriptions for illustrative purposes, and NR terms are used in most of the following descriptions, although these technologies can also be applied to an application other than an NR system application, for example, a 6th Generation (6G) communication system.

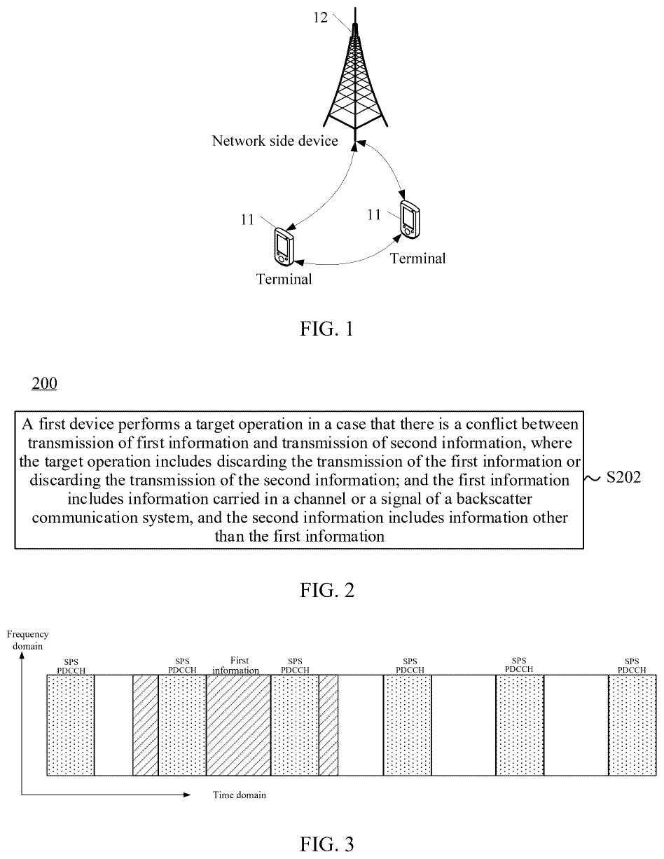

FIG. 1 is a block diagram of a wireless communication system to which embodiments of this application are applicable. The wireless communication system includes terminals 11 and a network side device 12. The terminal 11 may be a terminal side device, for example, a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a Vehicle-Mounted Device (VUE), Pedestrian User Equipment (PUE), a smart home (a home device with a wireless communication function, for example, a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart anklet, or a smart chain anklet), a smart wrist strap, smart clothes, or the like. It should be noted that a specific type of the terminal 11 is not limited in embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access node, a Wireless Fidelity (Wi-Fi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. Provided that a same technical effect is achieved, the base station is not limited to a specified technical term. It should be noted that, in embodiments of this application, only a base station in an NR system is used as an example, but a specific type of the base station is not limited.

The following describes in detail a conflict processing method provided in embodiments of this application through some embodiments and application scenarios thereof with reference to the accompanying drawings.

As shown in FIG. 2, an embodiment of this application provides a conflict processing method 200. The method may be performed by a terminal. In other words, the method may be performed by software or hardware installed in the terminal. The method may, for example, be performed by a network side device. In other words, the method may be performed by software or hardware installed in the network side device. The method includes the following steps.

S202: A first device performs a target operation in a case that there is a conflict between transmission of first information and transmission of second information, where the target operation includes discarding the transmission of the first information or discarding the transmission of the second information; and the first information includes information carried in a channel or a signal of a backscatter communication system, and the second information includes information other than the first information.

In embodiments of this application, the first device may be a terminal, or may be a network side device. The following embodiments are mainly described by using an example in which the first device is the terminal.

It should be noted that “discard” in this embodiment includes two meanings: cancel or delay. In addition, discarding the transmission of the second information may also be understood as discarding transmission of a conflict part of the second information.

For example, in this embodiment, the first device may transmit the first information, and delay or cancel the transmission of the second information in a case that there is the conflict between the transmission of the first information and the transmission of the second information.

For another example, in this embodiment, the first device may transmit the second information, and delay or cancel the transmission of the first information in a case that there is the conflict between the transmission of the first information and the transmission of the second information.

It should be noted that “transmission” mentioned in embodiments of this application may include transmitting or receiving.

In some embodiments, the first information may include at least one of the following:
(1) carrier information, namely, a carrier signal (or referred to as an excitation signal), where the carrier information may be information sent by the network side device to a tag (tag) device, or may be information sent by the terminal to a tag device, and the carrier information may be a carrier signal or channel;
(2) control information, where the control information includes, for example, a selection signal, a query signal, a repeated query signal, a reply signal, a read signal, a write signal, a random request signal, and the like, the control information may be information sent by the network side device to the tag device, or may be information sent by the terminal to the tag device, and the control information may be a carrier signal or channel; and
(3) feedback information, namely, a feedback channel or signal, which may be a tag feedback, where the feedback information may be information sent by the tag device to the terminal through backscattering, or may be information sent by the tag device to the network side device through backscattering, and the feedback information includes, for example, an RN16 (Random Number 16) or an Electronic Product Code (EPC), where the RN16 may be a 16-bit random number temporarily representing a tag device/terminal identity.

In some embodiments, the second information may include information carried in at least one of the following: a Physical Downlink Shared Channel (PDSCH), a synchronization signal/physical broadcast channel signal block/Synchronization Signal Block (SSB), a Channel State Information Reference Signal (CSI-RS), a Sounding Reference Signal (SRS), a Physical Random Access Channel (PRACH), a Physical Uplink Control Channel (PUCCH), and a Physical Uplink Shared Channel (PUSCH). In an example, the second information is an NR channel or signal.

According to the conflict processing method provided in this embodiment of this application, the first device may discard the transmission of the first information or discard the transmission of the second information in a case that there is the conflict between the transmission of the first information and the transmission of the second information; and the first information includes the information carried in the channel or the signal of the backscatter communication system, and the second information includes the information other than the first information. In this embodiment of this application, a decrease in communication reliability due to the transmission conflict can be reduced or avoid, and communication robustness can be improved.

In some embodiments, that a first device performs a target operation in a case that there is a conflict between transmission of first information and transmission of second information includes: The first device performs the target operation based on at least one of the following in a case that there is the conflict between the transmission of the first information and the transmission of the second information: carried content, a transmission direction, a transmission channel, a periodicity, a purpose, and a function of the first information, and/or carried content, a transmission direction, a transmission channel, a periodicity, a purpose, and a function of the second information.

In this embodiment, for example, the terminal performs the target operation based on the carried content and the periodicity of the first information and the carried content and the periodicity of the second information in a case that there is the conflict between the transmission of the first information and the transmission of the second information. For example, in a case that the carried content of the first information is control information and the carried content of the second information is a periodic channel or signal, the foregoing target operation includes: transmitting the first information, and discarding the transmission of the second information.

In some embodiments, the first information includes at least one of the carrier information, the control information, and the feedback information, and at least two of the carrier information, the control information and the feedback information correspond to different channels, and the channel includes at least one of a transmission channel, a logical channel, and a physical channel.

In this embodiment, for example, the carrier information, the control information, and the feedback information respectively correspond to different channels, and the channel is similar to a PDSCH, a Physical Downlink Control Channel (PDCCH), a PUCCH, a PUSCH, or the like.

In some embodiments, the first information includes at least one of the carrier information, the control information, and the feedback information, and at least two of the carrier information, the control information, and the feedback information correspond to different priorities of a logical channel.

In some embodiments, at least two of the carrier information, the control information, and the feedback information are mapped to different logical channels for transmission.

In this embodiment, different content of the first information may correspond to different priorities of the logical channel. Therefore, target operations performed by the first device may also be different in a case that there is the conflict between the transmission of the first information and the transmission of the second information. For example, the priority of the logical channel corresponding to the control information is higher than the priority of the logical channel corresponding to the carrier information. In a case that the first information is the control information, and the second information is a periodic channel or signal, the first device may transmit the control information, and discard transmission of the periodic channel or signal. In a case that the first information is the carrier information, and the second information is a periodic channel or signal, the first device may transmit the periodic channel or signal, and discard transmission of the carrier information.

In some embodiments, on a basis of the foregoing embodiments, the second information includes third information and fourth information, and that a first device performs a target operation in a case that there is a conflict between transmission of first information and transmission of second information includes: The first device discards the first information in a case that the first information is the carrier information, and there is a conflict between the transmission of the first information and transmission of the third information; and the first device discards the fourth information in a case that the first information is the carrier information, and there is a conflict between the transmission of the first information and transmission of the fourth information.

The third information includes information carried in at least one of the following: an aperiodic channel or signal (for example, a dynamically scheduled NR signal or channel), an SSB, a PRACH, a Scheduling Request (SR), a Buffer Status Report (BSR), Downlink Control Information (DCI) scrambled by a first radio network temporary identity (RNTI), a specific type of PDCCH, and a PUCCH.

The first RNTI includes, for example, a Paging Radio Network Temporary Identity (P-RNTI), a System Information Radio Network Temporary Identity (SI-RNTI), a Random Access Radio Network Temporary Identity (RA-RNTI), a Temporary Cell Radio Network Temporary Identity (TC-RNTI), a Paging Early Indication Radio Network Temporary Identity (PEI-RNTI), or a random access Message B Radio Network Temporary Identity (Msg-B RNTI).

The specific type of PDCCH includes, for example, a PDCCH corresponding to a type 0-2A common search space set (Type 0-2A Common Search Space set, Type 0-2A CSS set).

The BSR may be a specific type of BSR, for example, a periodically triggered BSR, and the SR may be a specific type of SR. The specific type of SR is an SR corresponding to a specific logical channel or the like. This is not limited herein.

The fourth information includes information carried in at least one of the following: (1) a periodic channel or signal, for example, a periodic CSI-RS, and (2) a semi-static channel or signal, for example, a Semi-Static Scheduling (SPS) PDSCH, or a Configuration Grant Physical Uplink Shared Channel (CG PUSCH).

In some embodiments, the second information includes fifth information and sixth information, and that a first device performs a target operation in a case that there is a conflict between transmission of first information and transmission of second information includes: The first device discards the fifth information in a case that the first information is the control information or the feedback information, and there is a conflict between the transmission of the first information and transmission of the fifth information; and the first device discards the first information in a case that the first information is the control information or the feedback information, and there is a conflict between the transmission of the first information and transmission of the sixth information.

The fifth information includes information carried in at least one of the following: (1) a periodic channel or signal, for example, a periodic CSI-RS, and (2) a semi-static channel or signal, for example, an SPS PDSCH or a CG PUSCH.

The sixth information includes information carried in at least one of the following: an aperiodic channel or signal, a specific type of PRACH, an SR, a BSR, an SSB for a specific function, DCI scrambled by a second RNTI, and a specific type of PDCCH.

The specific type of PRACH includes a PRACH for Beam Failure Recovery (BFR).

The SSB for a specific function includes at least one of the following: an SSB for Radio Link Monitoring (RLM) measurement; an SSB received during running of a T310 timer, where the T310 timer is used to determine whether a radio link failure occurs; an SSB for synchronization or timing; an SSB for Automatic Gain Control (AGC) adjustment; and an SSB for BFR.

In some embodiments, that a first device performs a target operation in a case that there is a conflict between transmission of first information and transmission of second information includes: The first device performs the target operation based on a standard of the communication system in a case that there is the conflict between the transmission of the first information and the transmission of the second information, where the standard of the communication system includes, for example, Frequency Division Duplexing (FDD), Time Division Duplexing (TDD), and the like.

In this embodiment, in different standards, transmission priorities of the first information and the second information may be different. For example, in a first standard, the transmission priority of the first information is higher than the transmission priority of the second information; and in a case that there is the conflict between the transmission of the first information and the transmission of the second information, the first device discards the transmission of the second information. In a second standard, the transmission priority of the first information is lower than the transmission priority of the second information; and in a case that there is the conflict between the transmission of the first information and the transmission of the second information, the first device discards the transmission of the first information.

In some embodiments, in the foregoing embodiments, the conflict between the transmission of the first information and the transmission of the second information may include at least one of the following:
(1) there is overlapping between the transmission of the first information and the transmission of the second information in time domain;
(2) there is overlapping between the transmission of the first information and the transmission of the second information in frequency domain;
(3) a time gap between the transmission of the first information and the transmission of the second information is less than a first specific value, and a unit of the first specific value may be a time unit such as a symbol; and
(4) a frequency domain gap between the transmission of the first information and the transmission of the second information is less than a second specific value, and a unit of the second specific value may be a frequency unit such as a resource unit.

In an embodiment, a value or a value range of the first specific value or the second specific value is specified by the network side device or protocol-specified.

In an embodiment, the terminal or the network side device needs to schedule or transmit the first information and the second information on a basis that the first specific value or the second specific value is met, to ensure that there is no overlapping between the first information and the second information.

In some embodiments, in the foregoing embodiments, in a case that the first device is the terminal, the method further includes: The first device (the terminal) does not transmit the second information in a first time period starting from reception of first control information, where the first control information is to schedule the transmission of the first information.

It may be understood that not transmitting the second information means that the terminal assumes that there is no transmission of the second information in the first time period.

In some embodiments, in the foregoing embodiments, in a case that the first device is the network side device, the method further includes: The network side device does not transmit the second information in a first time period starting from sending of first control information, where the first control information is to schedule the transmission of the first information.

In an embodiment, the first time period starting from reception of the first control information by the terminal is a first time period starting from an end moment of a time unit in which the first control information is received.

In this embodiment, a length of the first time period may be related to the following content: a difference between a start transmission moment of the first information and a moment at which the first control information is received.

In some embodiments, in a case that the first device is the terminal, before the terminal performs the target operation, the method further includes: The terminal reports a first capability, where the first capability includes at least one of the following:
(1) whether the terminal supports transmitting and receiving the first information and the second information simultaneously;
(2) a Radio Frequency (RF) capability, where the RF capability is to indicate a quantity of transceiver chains supported by the terminal; and
(3) a receiver capability of the terminal, where the receiver capability includes at least one of whether multiple receivers are supported and a quantity of supported receivers. The multiple receivers mentioned in this embodiment include, for example, a main receiver and an additional receiver, and the additional receiver includes, for example, a low power receiver. The main receiver is a main communication module, and is to send and receive mobile communication data, for example, a PDSCH or a PUSCH, and the low power receiver is to receive the first information.

In this embodiment, that a first device performs a target operation in a case that there is a conflict between transmission of first information and transmission of second information includes: The terminal performs the target operation in a case that the first capability meets at least one of the following, and there is the conflict between the transmission of the first information and the transmission of the second information:
(1) the terminal does not support transmitting and receiving the first information and the second information simultaneously;
(2) the RF capability indicates that the quantity of transceiver chains supported by the terminal is less than 2; and
(3) the receiver capability of the terminal is at least one of supporting only one receiver, not supporting multiple receivers, and not supporting an additional receiver for receiving the first information.

It should be noted that the foregoing embodiment in which the terminal reports the first capability may be implemented on a basis of the embodiment 200, or may be separately implemented independent of the embodiment 200.

In the foregoing described embodiments, the first device (the terminal) may perform the target operation according to a protocol agreement or a configuration of the network side device. In another embodiment, the terminal may also perform the target operation according to a dynamic indication of the network side device.

In some embodiments, on a basis of the embodiment 200, the first device performs a target operation in a case that there is a conflict between transmission of first information and transmission of second information includes: The first device performs the target operation based on a transmission priority of the first information in a case that there is the conflict between the transmission of the first information and the transmission of the second information, where the transmission priority may be dynamically indicated by the network side device, and the transmission priority may be a priority of the first information compared with that of the second information.

In some embodiments, the priority of the first information may be carried by second control information (for example, DCI). This embodiment may further include the following steps: The first device (the terminal) receives the second control information, where the second control information is for at least one of the following: scheduling the transmission of the first information and indicating the transmission priority of the first information.

In this embodiment, for example, the network side device indicates the transmission priority of the scheduled first information by using the DCI. If the transmission priority is indicated as a high priority, the terminal preferably transmits the first information; or if the transmission priority is not indicated or is indicated as a low priority, the terminal preferentially transmits the second information. For example, if urgent first information (for example, control information) needs to be transmitted, the first information may conflict with another NR channel, for example, a PUCCH and a PUSCH. In this case, first information of a high priority may be indicated by using the DCI to cancel or delay transmission of a low-priority channel or signal that conflicts with the first information.

To describe in detail the conflict processing method provided in this embodiment of this application, the following describes the conflict processing method with reference to a specific embodiment.

As shown in FIG. 3, in this embodiment, in a case that there is a conflict between transmission of a first signal/channel (the first information in FIG. 3, filled with slashes) and transmission of an NR signal/channel (the SPS PDSCH in FIG. 3, filled with small black dots), the terminal delays the transmission of the NR signal/channel (the second SPS PDSCH and the third SPS PDSCH in FIG. 3). That is, in an overlapping part of the first signal/channel and the NR signal/channel, the terminal may assume that the first channel/signal is currently received instead of the NR channel/signal.

In this embodiment, a delay requirement for the transmission of the first channel/signal may be strict, that is, the first channel/signal needs to be transmitted within a specific time range. In this case, the transmission of the NR channel/signal can be appropriately delayed. That is, a network may preferentially transmit the first signal/channel and delay transmission of the SPS PDSCH.

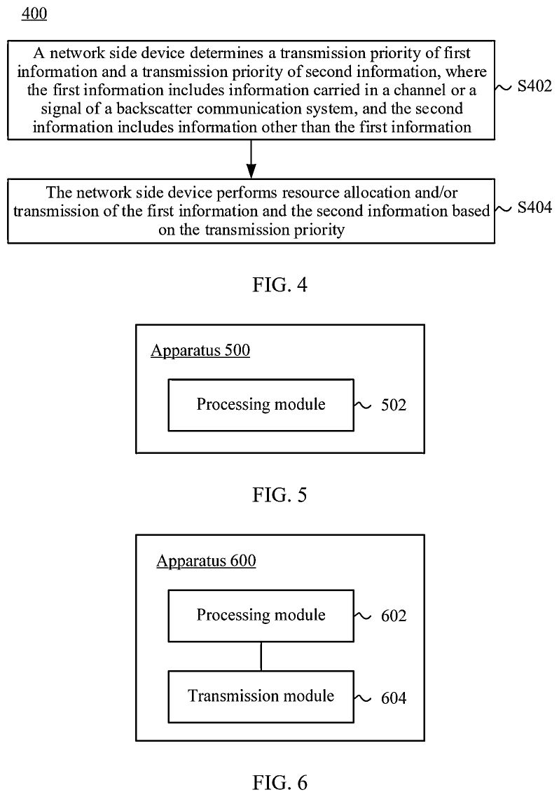

The conflict processing method according to this embodiment of this application is described in detail above with reference to FIG. 2. A conflict processing method according to another embodiment of this application is described in detail below with reference to FIG. 4. It may be understood that interaction between a network side device and a terminal described from the network side device is the same as or corresponds to that described from the terminal side in the method shown in FIG. 2. To avoid repetition, related descriptions are appropriately omitted.

FIG. 4 is a schematic flowchart of implementing a conflict processing method according to an embodiment of this application. The method may be applied to a network side device. As shown in FIG. 4, the method 400 includes the following steps.

S402: The network side device determines a transmission priority of first information and a transmission priority of second information, where the first information includes information carried in a channel or a signal of a backscatter communication system, and the second information includes information other than the first information.

S404: The network side device performs resource allocation and/or transmission of the first information and the second information based on the transmission priority.

In this embodiment of the this application, the network side device determines the transmission priority of the first information and the transmission priority of the second information, and performs resource allocation and/or transmission of the first information and the second information based on the transmission priority, where the first information includes the information carried in the channel or the signal of the backscatter communication system, and the second information includes the information other than the first information. In embodiments of this application, a decrease in communication reliability due to the transmission conflict can be reduced or avoid, and communication robustness can be improved.

In this embodiment, the transmission priority of the first information compared with that of the second information may be configured by the network side device or protocol-specified. The transmission priority includes a priority of a logical channel of the first information compared with that of the second information. The network side device preferentially transmits information of a high priority, or preferentially allocates a transmission resource to the information of the high priority. Therefore, the conflict occurred between the first information and the second information may be avoided from a source. For example, if the network side device configures that the transmission priority of the first information is lower than that of the second information, the network side device preferably transmits the second information; and vice versa.

The conflict processing method provided in this embodiment of this application may be performed by a conflict processing apparatus. In this embodiment of this application, an example in which the conflict processing apparatus performs the conflict processing method is used, to describe the conflict processing apparatus provided in this embodiment of this application.

FIG. 5 is a schematic structural diagram of a conflict processing apparatus according to an embodiment of this application. The apparatus may correspond to a terminal or a network side device in another embodiment. As shown in FIG. 5, the apparatus 500 includes the following module.

A processing module 502 is configured to perform a target operation in a case that there is a conflict between transmission of first information and transmission of second information, where the target operation includes discarding the transmission of the first information or discarding the transmission of the second information; and the first information includes information carried in a channel or a signal of a backscatter communication system, and the second information includes information other than the first information.

In some embodiments, the apparatus 500 may further include a transmission module.

In this embodiment of the this application, the processing module may discard the transmission of the first information or discard the transmission of the second information in a case that there is the conflict between the transmission of the first information and the transmission of the second information; and the first information includes the information carried in the channel or the signal of the backscatter communication system, and the second information includes the information other than the first information. In embodiments of this application, a decrease in communication reliability due to the transmission conflict can be reduced or avoid, and communication robustness can be improved.

In some embodiments, in an embodiment, the processing module 502 is configured to perform the target operation based on at least one of the following in a case that there is the conflict between the transmission of the first information and the transmission of the second information: carried content, a transmission direction, a transmission channel, a periodicity, a purpose, and a function of the first information, and/or carried content, a transmission direction, a transmission channel, a periodicity, a purpose, and a function of the second information.

In some embodiments, in an embodiment, the first information includes at least one of carrier information, control information, and feedback information.

In some embodiments, in an embodiment, at least two of the carrier information, the control information, and the feedback information correspond to different channels, and the channel includes at least one of a transmission channel, a logical channel, and a physical channel. In some embodiments, in an embodiment, at least two of the carrier information, the control information, and the feedback information correspond to different priorities of a logical channel.

In some embodiments, in an embodiment, the second information includes third information and fourth information, and the processing module 502 is configured to: discard the first information in a case that the first information is the carrier information, and there is a conflict between the transmission of the first information and transmission of the third information; and discard the fourth information in a case that the first information is the carrier information, and there is a conflict between the transmission of the first information and transmission of the fourth information.

In some embodiments, in an embodiment, the second information includes fifth information and sixth information, and the processing module 502 is configured to: discard the fifth information in a case that the first information is the control information or the feedback information, and there is a conflict between the transmission of the first information and transmission of the fifth information; and discard the first information in a case that the first information is the control information or the feedback information, and there is a conflict between the transmission of the first information and transmission of the sixth information.

In some embodiments, in an embodiment, the processing module 502 is configured to perform the target operation based on a standard of the communication system in a case that there is the conflict between the transmission of the first information and the transmission of the second information.

In some embodiments, in an embodiment, the conflict between the transmission of the first information and the transmission of the second information includes at least one of the following: (1) there is overlapping between the transmission of the first information and the transmission of the second information in time domain; (2) there is overlapping between the transmission of the first information and the transmission of the second information in frequency domain; (3) a time gap between the transmission of the first information and the transmission of the second information is less than a first specific value; and (4) a frequency domain gap between the transmission of the first information and the transmission of the second information is less than a second specific value.

In some embodiments, in an embodiment, the apparatus is a terminal, and the apparatus further includes a transmission module, configured to not transmit the second information in a first time period starting from reception of first control information, where the first control information is to schedule the transmission of the first information.

In some embodiments, in an embodiment, the apparatus is a terminal, and the apparatus further includes a transmission module, configured to report a first capability, where the first capability includes at least one of the following: (1) whether the apparatus supports transmitting and receiving the first information and the second information simultaneously; (2) an RF capability, where the RF capability is to indicate a quantity of transceiver chains supported by the apparatus; and (3) a receiver capability of the apparatus, where the receiver capability includes at least one of whether multiple receivers are supported and a quantity of supported receivers.

In some embodiments, in an embodiment, the processing module 502 is configured to perform the target operation in a case that the first capability meets at least one of the following, and there is the conflict between the transmission of the first information and the transmission of the second information: (1) the apparatus does not support transmitting and receiving the first information and the second information simultaneously; (2) the RF capability indicates that the quantity of transceiver chains supported by the apparatus is less than 2; and (3) the receiver capability of the apparatus is at least one of supporting only one receiver, not supporting multiple receivers, and not supporting an additional receiver for receiving the first information.

In some embodiments, in an embodiment, the processing module 502 is configured to perform the target operation based on a transmission priority of the first information in a case that there is the conflict between the transmission of the first information and the transmission of the second information.

The apparatus 500 in this embodiment of this application may correspond to the procedures of the method 200 in the embodiment of this application, and units/modules in the apparatus 500 and the foregoing other operations and/or functions are separately for implementing the corresponding procedures of the method 200, and can achieve a same or equivalent technical effect. For brevity, details are not described herein again.

The conflict processing apparatus in this embodiment of this application may be an electronic device, for example, an electronic device with an operating system, or may be a component, for example, an integrated circuit or a chip, in the electronic device. The electronic device may be a terminal, or may be a device other than the terminal. For example, the terminal may include but is not limited to the foregoing listed types of the terminal 11. The another device may be a server, a Network Attached Storage (NAS), or the like. This is not specifically limited in this embodiment of this application.

FIG. 6 is a schematic structural diagram of a conflict processing apparatus according to an embodiment of this application. The apparatus may correspond to a network side device in another embodiment. As shown in FIG. 6, the apparatus 600 includes the following modules.

A processing module 602 may be configured to determine a transmission priority of first information and a transmission priority of second information, where the first information includes information carried in a channel or a signal of a backscatter communication system, and the second information includes information other than the first information; and a transmission module 604 may be configured to perform resource allocation and/or transmission of the first information and the second information based on the transmission priority.

In this embodiment of the this application, the processing module may determine the transmission priority of the first information and the transmission priority of the second information, and the transmission module performs resource allocation and/or transmission of the first information and the second information based on the transmission priority, where the first information includes the information carried in the channel or the signal of the backscatter communication system, and the second information includes the information other than the first information. In embodiments of this application, a decrease in communication reliability due to the transmission conflict can be reduced or avoid, and communication robustness can be improved.

The apparatus 600 in this embodiment of this application may correspond to the procedures of the method 400 in the embodiment of this application, and units/modules in the apparatus 600 and the foregoing other operations and/or functions are separately for implementing the corresponding procedures of the method 400, and can achieve a same or equivalent technical effect. For brevity, details are not described herein again.

The conflict processing apparatus provided in this embodiment of this application can implement the processes implemented in the method embodiments from FIG. 2 to FIG. 4, and a same technical effect can be achieved. To avoid repetition, details are not described herein again.

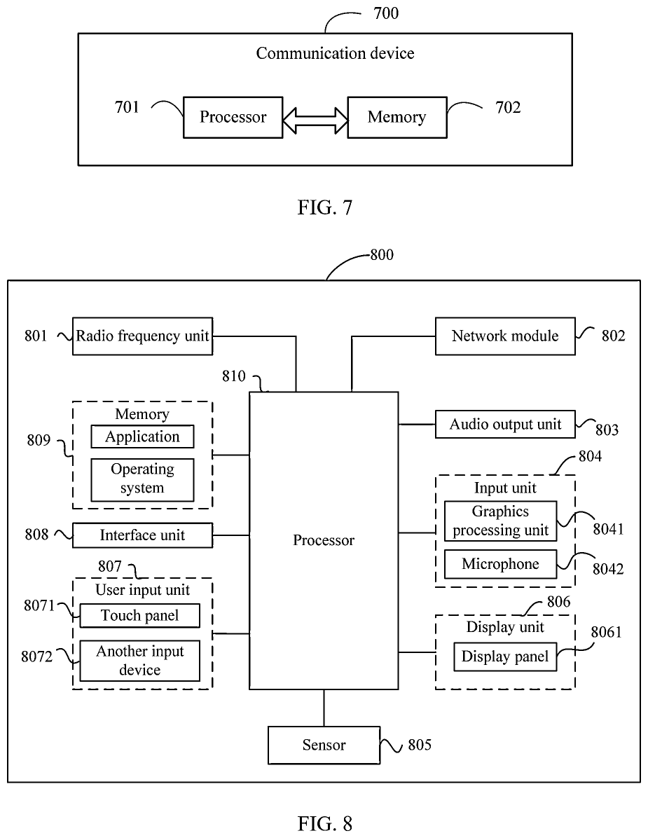

In some embodiments, as shown in FIG. 7, an embodiment of this application further provides a communication device 700. The communication device 700 includes a processor 701 and a memory 702, and the memory 702 stores a program or an instruction that can be run on the processor 701. For example, when the communication device 700 is a terminal, and the program or the instruction is executed by the processor 701, steps of the foregoing conflict processing method embodiments are implemented, and a same technical effect can be achieved. When the communication device 700 is a network side device, and the program or the instruction is executed by the processor 701, steps of the foregoing conflict processing method embodiments are implemented, and a same technical effect can be achieved. To avoid repetition, details are not described herein again.

An embodiment of this application further provides a terminal. The terminal includes a processor and a communication interface. The processor is configured to perform a target operation in a case that there is a conflict between transmission of first information and transmission of second information, where the target operation includes discarding the transmission of the first information or discarding the transmission of the second information; and the first information includes information carried in a channel or a signal of a backscatter communication system, and the second information includes information other than the first information. This terminal embodiment corresponds to the foregoing method embodiment of the terminal side, each implementation process and implementation of the foregoing method embodiment can be applied to this terminal embodiment, and a same technical effect can be achieved. For example, FIG. 8 is a schematic diagram of a hardware structure of a terminal according to an embodiment of this application.

The terminal 800 includes but is not limited to at least a part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art can understand that the terminal 800 may further include a power supply (such as a battery) that supplies power to each component. The power supply may be logically connected to the processor 810 by using a power supply management system, to implement functions such as charging and discharging management, and power consumption management by using the power supply management system. The structure of the terminal shown in FIG. 8 does not constitute a limitation on the terminal. The terminal may include more or fewer components than those shown in the figure, or combine some components, or have different component arrangements. Details are not described herein.

It should be understood that in this embodiment of this application, the input unit 804 may include a Graphics Processing Unit (GPU) 8041 and a microphone 8042. The graphics processing unit 8041 processes image data of a static picture or a video obtained by an image capture apparatus (for example, a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 801 may transmit the downlink data to the processor 810 for processing. In addition, the radio frequency unit 801 may send uplink data to the network side device. Usually, the radio frequency unit 801 includes but is not limited to an antenna, an amplifier, a transceiver, a coupler, a low noise amplifier, a duplexer, and the like.

The memory 809 may be configured to store a software program or an instruction and various data. The memory 809 may mainly include a first storage area for storing a program or an instruction and a second storage area for storing data. The first storage area may store an operating system, an application or an instruction required by at least one function (for example, a sound playing function or an image playing function), and the like. In addition, the memory 809 may be a volatile memory or a non-volatile memory, or the memory 809 may include a volatile memory and a non-volatile memory. The non-volatile memory may be a Read-Only Memory (ROM), a Programmable Read-Only Memory (PROM), an Erasable Programmable Read-Only Memory (EPROM), an Electrically Erasable Programmable Read-Only Memory (EEPROM), or a flash memory. The volatile memory may be a Random Access Memory (RAM), a Static Random Access Memory (SRAM), a Dynamic Random Access Memory (DRAM), a Synchronous Dynamic Random Access Memory (SDRAM), a Double Data Rate Synchronous Dynamic Random Access Memory (DDR SDRAM), an Enhanced Synchronous Dynamic Random Access Memory (ESDRAM), a Synch Link Dynamic Random Access Memory (SLDRAM), and a Direct Rambus Random Access Memory (DR RAM). The memory 809 in this embodiment of this application includes but is not limited to these memories and any memory of another proper type.

The processor 810 may include one or more processing units. In some embodiments, an application processor and a modem processor are integrated into the processor 810. The application processor mainly processes operations of an operating system, a user interface, an application, and the like. The modem processor mainly processes a wireless communication signal, for example, a baseband processor. It may be understood that, in some embodiments, the modem processor may not be integrated into the processor 810.

The processor 810 may be configured to perform a target operation in a case that there is a conflict between transmission of first information and transmission of second information, where the target operation includes discarding the transmission of the first information or discarding the transmission of the second information; and the first information includes information carried in a channel or a signal of a backscatter communication system, and the second information includes information other than the first information.

In this embodiment of the this application, the terminal may discard the transmission of the first information or discard the transmission of the second information in a case that there is the conflict between the transmission of the first information and the transmission of the second information; and the first information includes the information carried in the channel or the signal of the backscatter communication system, and the second information includes the information other than the first information. In embodiments of this application, a decrease in communication reliability due to the transmission conflict can be reduced or avoid, and communication robustness can be improved.

The terminal 800 provided in this embodiment of this application may further implement the processes of the foregoing conflict processing method embodiments, and a same technical effect can be achieved. To avoid repetition, details are not described herein again.

An embodiment of this application further provides a network side device. The network side device includes a processor and a communication interface. The processor is configured to perform a target operation in a case that there is a conflict between transmission of first information and transmission of second information, where the target operation includes discarding the transmission of the first information or discarding the transmission of the second information; and the first information includes information carried in a channel or a signal of a backscatter communication system, and the second information includes information other than the first information. For example, the processor is configured to determine a transmission priority of first information and a transmission priority of second information, where the first information includes information carried in a channel or a signal of a backscatter communication system, and the second information includes information other than the first information; and the communication interface is configured to perform resource allocation and/or transmission of the first information and the second information based on the transmission priority. This network side device embodiment corresponds to the foregoing method embodiment of the network side device, each implementation process and implementation of the foregoing method embodiment can be applied to this network side device embodiment, and a same technical effect can be achieved.

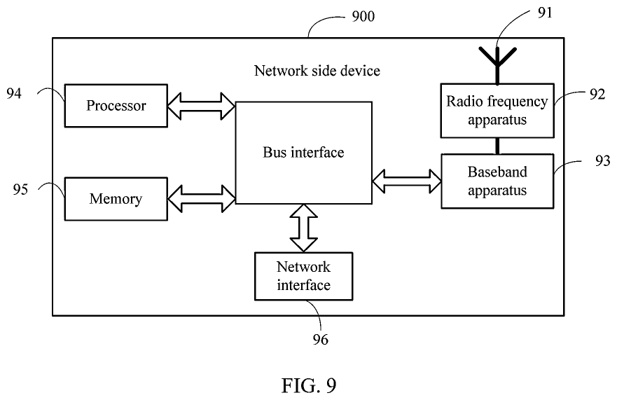

For example, an embodiment of this application further provides a network side device. As shown in FIG. 9, the network side device 900 includes an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information through the antenna 91, and sends the received information to the baseband apparatus 93 for processing. In a downlink direction, the baseband apparatus 93 processes information that needs to be sent, and sends processed information to the radio frequency apparatus 92. The radio frequency apparatus 92 processes the received information, and sends processed information through the antenna 91.

In the foregoing embodiment, the method performed by the network side device may be implemented in the baseband apparatus 93. The baseband apparatus 93 includes a baseband processor.

The baseband apparatus 93 may include, for example, at least one baseband board. Multiple chips are disposed on the baseband board. As shown in FIG. 9, one chip is, for example, the baseband processor, and is connected to the memory 95 through a bus interface, to invoke a program in the memory 95, to perform the operations of the network side device shown in the foregoing method embodiments.

The network side device may further include a network interface 96, and the interface is, for example, a Common Public Radio Interface (CPRI).

For example, the network side device 900 in this embodiment of the present disclosure further includes an instruction or a program that is stored in the memory 95 and that can be run on the processor 94. The processor 94 invokes the instruction or the program in the memory 95 to perform the method performed by the modules shown in FIG. 5 or FIG. 6, and a same technical effect is achieved. To avoid repetition, details are not described herein again.

An embodiment of this application further provides a readable storage medium. The readable storage medium stores a program or an instruction. When the program or the instruction is executed by a processor, the processes of the foregoing conflict processing method embodiments are implemented, and a same technical effect can be achieved. To avoid repetition, details are not described herein again.

The processor is a processor in the terminal in the foregoing embodiments. The readable storage medium includes a computer-readable storage medium such as a computer ROM, a RAM, a magnetic disk, or an optical disc.

An embodiment of this application further provides a chip. The chip includes a processor and a communication interface, the communication interface is coupled to the processor, the processor is configured to run a program or an instruction, to implement the processes of the foregoing conflict processing method embodiments, and a same technical effect can be achieved. To avoid repetition, details are not described herein again.

It should be understood that the chip mentioned in this embodiment of this application may also be referred to as a system-level chip, a system chip, a chip system, or a system-on-a-chip chip.

An embodiment of this application further provides a computer program/program product. The computer program/program product is stored in a storage medium, the computer program/program product is executed by at least one processor to implement the foregoing conflict processing method embodiments, and a same technical effect can be achieved. To avoid repetition, details are not described herein again.

An embodiment of this application further provides a conflict processing system. The conflict processing system includes a terminal and a network side device. The terminal may be configured to perform the steps of the conflict processing method, and the network side device may be configured to perform the steps of the conflict processing method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements that are not expressly listed, or further includes elements inherent to this process, method, article, or apparatus. In absence of more constraints, an element preceded by “includes a . . . ” does not preclude the presence of additional identical elements in the process, method, article, or apparatus that includes the element. In addition, it should be noted that the scope of the method and the apparatus in embodiments of this application is not limited to performing functions in an illustrated or discussed sequence, and may also include performing functions in a basically simultaneous manner or in a reverse sequence based on the functions concerned. For example, the described method may be performed in an order different from the described order, and the steps may be added, omitted, or combined. In addition, features described with reference to some examples may be combined in other examples.

Based on the descriptions of the foregoing implementations, a person skilled in the art may clearly understand that the method in the foregoing embodiments may be implemented by software in addition to a necessary universal hardware platform or by hardware only. In most circumstances, the former is a an example implementation. Based on such an understanding, the technical solutions of this application essentially or the part contributing to the prior art may be implemented in a form of a computer software product. The computer software product is stored in a storage medium (for example, a ROM/RAM, a hard disk, or an optical disc), and includes several instructions for instructing a terminal (which may be a mobile phone, a computer, a server, an air conditioner, a network device, or the like) to perform the method described in embodiments of this application.

Embodiments of this application are described above with reference to the accompanying drawings. However, this application is not limited to the foregoing specific implementations. The foregoing specific implementations are merely examples, but are not limitative. Under the enlightenment of this application, a person of ordinary skill in the art may further make many forms without departing from the purpose of this application and the protection scope of the claims, and all the forms fall within the protection of this application.

The invention claimed is:

1. A conflict processing method, comprising:
performing, by a first device, a target operation when a conflict exists between transmission of first information and transmission of second information,
wherein the target operation comprises discarding the transmission of the first information or discarding the transmission of the second information, the first information comprises information carried in a channel or a signal of a backscatter communication system, and the second information comprises information other than the first information.

2. The method according to claim 1, wherein the performing, by the first device, the target operation when a conflict exists between the transmission of the first information and the transmission of the second information comprises:
when the conflict exists between the transmission of the first information and the transmission of the second information, performing, by the first device, the target operation based on at least one of the following:
carried content, a transmission direction, a transmission channel, a periodicity, a purpose, or a function of the first information, or carried content, a transmission direction, a transmission channel, a periodicity, a purpose, or a function of the second information.

3. The method according to claim 1, wherein the first information comprises at least one of the following: carrier information, control information, or feedback information.

4. The method according to claim 3, wherein at least two of the carrier information, the control information, or the feedback information correspond to different channels, and a channel comprises at least one of a transmission channel, a logical channel, or a physical channel.

5. The method according to claim 3, wherein at least two of the carrier information, the control information, or the feedback information correspond to different logical channel priorities.

6. The method according to claim 1, wherein the second information comprises third information and fourth information, and the performing, by the first device, the target operation when the conflict exists between the transmission of the first information and the transmission of the second information comprises:
discarding, by the first device, the first information when the first information is carrier information, and the conflict exists between the transmission of the first information and transmission of the third information; and
discarding, by the first device, the fourth information when the first information is the carrier information, and the conflict exists between the transmission of the first information and transmission of the fourth information.

7. The method according to claim 1, wherein the second information comprises fifth information and sixth information, and the performing, by the first device, the target operation when the conflict exists between the transmission of the first information and the transmission of the second information comprises:
discarding, by the first device, the fifth information when the first information is control information or feedback information, and the conflict exists between the transmission of the first information and transmission of the fifth information; and
discarding, by the first device, the first information when the first information is the control information or the feedback information, and the conflict exists between the transmission of the first information and transmission of the sixth information.

8. The method according to claim 1, wherein the performing, by the first device, the target operation when the conflict exists between the transmission of the first information and the transmission of the second information comprises:
performing, by the first device, the target operation based on a standard of the communication system when the conflict exists between the transmission of the first information and the transmission of the second information.

9. The method according to claim 1, wherein the conflict existing between the transmission of the first information and the transmission of the second information comprises at least one of the following:
an overlap exists between the transmission of the first information and the transmission of the second information in time domain;
an overlap exists between the transmission of the first information and the transmission of the second information in frequency domain;
a time gap between the transmission of the first information and the transmission of the second information is less than a first specific value; or
a frequency domain gap between the transmission of the first information and the transmission of the second information is less than a second specific value.

10. The method according to claim 1, wherein the first device is a terminal, and the method further comprises:
not transmitting, by the terminal, the second information in a first time period starting from reception of first control information, wherein the first control information is to schedule the transmission of the first information.

11. The method according to claim 1, wherein the first device is a terminal, and before the terminal performs the target operation, the method further comprises:
reporting, by the terminal, a first capability, wherein the first capability comprises at least one of the following:
whether the terminal supports transmitting and receiving the first information and the second information simultaneously;
a Radio Frequency (RF) capability, wherein the RF capability is to indicate a quantity of transceiver chains supported by the terminal; or
a receiver capability of the terminal, wherein the receiver capability comprises at least one of whether multiple receivers are supported or a quantity of supported receivers.

12. The method according to claim 11, wherein the performing, by the first device, the target operation when the conflict exists between the transmission of the first information and the transmission of the second information comprises:
performing, by the terminal, the target operation when the conflict exists between the transmission of the first information and the transmission of the second information, and the first capability meets at least one of the following:
the terminal does not support transmitting and receiving the first information and the second information simultaneously;
the RF capability indicates that the quantity of transceiver chains supported by the terminal is less than 2; or
the receiver capability of the terminal is at least one of supporting only one receiver, not supporting multiple receivers, or not supporting an additional receiver for receiving the first information.

13. The method according to claim 1, wherein the performing, by the first device, the target operation when the conflict exists between the transmission of the first information and the transmission of the second information comprises:
performing, by the first device, the target operation based on a transmission priority of the first information when the conflict exists between the transmission of the first information and the transmission of the second information.

14. The method according to claim 13, wherein the priority of the first information is carried by second control information.

15. A conflict processing method, comprising:
determining, by a network side device, a transmission priority of first information and a transmission priority of second information, wherein the first information comprises information carried in a channel or a signal of a backscatter communication system, and the second information comprises information other than the first information; and
performing, by the network side device, resource allocation or transmission of the first information and the second information based on the transmission priority.

16. A terminal, comprising a processor and a memory storing instructions, wherein the instructions, when executed by the processor, cause the processor to perform operations comprising:
performing a target operation when a conflict exists between transmission of first information and transmission of second information,
wherein the target operation comprises discarding the transmission of the first information or discarding the transmission of the second information, the first information comprises information carried in a channel or a signal of a backscatter communication system, and the second information comprises information other than the first information.

17. The terminal according to claim 16, wherein the performing the target operation when the conflict exists between the transmission of the first information and the transmission of the second information comprises:
when the conflict exists between the transmission of the first information and the transmission of the second information, performing the target operation based on at least one of the following:
carried content, a transmission direction, a transmission channel, a periodicity, a purpose, or a function of the first information, or carried content, a transmission direction, a transmission channel, a periodicity, a purpose, or a function of the second information.

18. The terminal according to claim 16, wherein the first information comprises at least one of the following: carrier information, control information, or feedback information.

19. The terminal according to claim 16, wherein the second information comprises third information and fourth information, and the performing the target operation when the conflict exists between the transmission of the first information and the transmission of the second information comprises:
discarding the first information when the first information is carrier information, and the conflict exists between the transmission of the first information and transmission of the third information; and
discarding the fourth information when the first information is the carrier information, and the conflict exists between the transmission of the first information and transmission of the fourth information.

20. The terminal according to claim 16, wherein the second information comprises fifth information and sixth information, and the performing the target operation when the conflict exists between the transmission of the first information and the transmission of the second information comprises:
discarding the fifth information when the first information is control information or feedback information, and the conflict exists between the transmission of the first information and transmission of the fifth information; and
discarding the first information when the first information is the control information or the feedback information, and the conflict exists between the transmission of the first information and transmission of the sixth information.
